(19) United States
(12) Patent Application Publication
(10) Pub. No.: US 2024/0056332 A1
(43) Pub. Date: Feb. 15, 2024

(54) SYMBOL FILTERING AT A PHY-SIDE of PHY-MAC INTERFACE

(71) Applicant: Microchip Technology Incorporated, Chandler, AZ (US)

(72) Inventors: William T. Baggett, Austin, TX (US); Dixon Chen, Shenzhen (CN); Venkatraman Iyer, Austin, TX (US)

(21) Appl. No.: 18/146,865

(22) Filed: Dec. 27, 2022

(30) Foreign Application Priority Data
Aug. 9, 2022 (CN) 202210950844.7

(51) Int. Cl. H04L 12/40

(52) U.S. Cl. CPC H04L 12/40032

(57) ABSTRACT

Disclosed examples include a method. The method includes: conveying symbols from a PHY toward a MAC via a PHY-side of PHY-MAC interface; and filtering one or more symbols at an input of a PHY-side of an interface wrapper of the PHY-side of the PHY-MAC interface. Disclosed examples include an apparatus. The apparatus includes: a PHY-side of PHY-MAC interface; and a logic circuit provided at the PHY-side of PHY-MAC interface, the logic circuit comprising a symbol filter to filter one or more symbols conveyed via the PHY-side of PHY-MAC interface.

### CROSS-REFERENCE TO RELATED APPLICATION

Pursuant to 35 U.S.C. § 119(a), this application claims the benefit of the filing date of Chinese Patent Application Serial No. 202210950844.7, filed Aug. 9, 2022, for “SYMBOL FILTERING AT A PHY-SIDE OF PHY-MAC INTERFACE,” the disclosure of which is hereby incorporated herein in its entirety by this reference.

### FIELD

One or more examples relate to physical layer (PHY)-media access controller (MAC) interfaces, and more specifically, one or more examples relate to PHY-side PHY-MAC interfaces, and PHY-side interface wrappers with symbol-filtered inputs.

### BACKGROUND

Interconnects are widely used to facilitate communication among devices of a network, sub-systems and systems. Generally speaking, electrical signals are transmitted on a physical medium (e.g., a bus, a coaxial cable, or a twisted pair, without limitation—generically referred to simply as a “line” or a “bus”) by the devices coupled to the physical medium.

According to the Open Systems Interconnection model (OSI model), Ethernet-based computer networking technologies use baseband transmission (i.e., electrical signals are discrete electrical pulses) to transmit data packets and ultimately messages that are communicated among network devices. According to the OSI model, specialized circuitry called a physical layer (PHY) device or controller is used to interface between an analog domain of a line (the physical medium) and a digital domain of a data link layer (also referred to herein simply as a “link layer”) that operates according to packet signaling. While the data link layer may include one or more sublayers, in Ethernet-based computer networking, a data link layer typically includes at least a media access control (MAC) layer that provides control abstraction of the physical layer. By way of non-limiting example, when transmitting data to another device on a network, a MAC controller may prepare frames for the physical medium, add error correction elements, and implement collision avoidance. Further, when receiving data from another device, a MAC controller may ensure integrity of received data and prepare frames for higher layers.

There are various network topologies that implement physical layers and link layers (and may include other layers, without limitation). The Peripheral Component Interconnect (PCI) standard and the Parallel Advanced Technology Attachment (Parallel ATA) standard, both in use since the early 1990's, may implement a multidrop bus topology. The trend since the early 2000's has been to use point-to-point bus topologies, for example, the PCI Express standard (PCIe) and the Serial ATA (SATA) standard implement point-to-point topologies.

A typical point-to-point bus topology may implement lines between each device (e.g., dedicated point-to-point, without limitation) or lines between devices and switches (e.g., switched point-to-point, without limitation). In a multidrop bus topology, a physical transmission medium is a shared bus and each network device is coupled to the shared bus, for example, via a circuit chosen based on the type of physical medium (e.g., coaxial or twisted pair, without limitation).

Point-to-point bus topologies, such as a dedicated point-to-point topology or a switched point-to-point topology, require more wires and therefore more expensive material than multidrop topologies due, in part, to the greater number of links between devices. In certain applications, such as automotive, there may be physical constraints that make it difficult to directly connect devices, and so a topology that does not require, or does not require as many, direct connections (e.g., a multidrop topology, without limitation) in a network or a sub-network may be less susceptible to, or hampered by, such constraints.

Devices that are on a baseband network (e.g., a multidrop network without limitation) share the same physical transmission medium (“shared transmission medium”), and typically use the entire bandwidth of that medium for transmission (stated another way, a signal used in baseband transmission occupies the entire bandwidth of the media). As a result, only one device on a baseband network may transmit at a given instant. So, media access control methods are sometimes used to handle contention for such a shared transmission medium.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram of an apparatus to filter symbols conveyed from a PHY toward a MAC via a PHY-side of PHY-MAC interface.

FIG. 2 is a block diagram of a PHY-side of PHY-MAC interface that includes symbol filtering, in accordance with one or more examples.

FIG. 3 is a block diagram of a PHY-side of PHY-MAC interface that includes symbol filtering, in accordance with one or more examples.

FIG. 4 is a block diagram depicting a symbol filter to filter at least partially based on detecting: a predetermined symbol, an indication of valid data, and an indication of out-of-band data, in accordance with one or more examples.

FIG. 5 is a block diagram depicting a symbol filter to filter at least partially based on detecting: a predetermined symbol, in accordance with one or more examples.

FIG. 6 is a block diagram depicting a symbol filter to filter at least partially based on an indication of valid data and an indication of out-of-band data, in accordance with one or more examples, in accordance with one or more examples.

FIG. 7 is a flow diagram depicting a process to filter symbols at a PHY-side of a PHY-MAC interface, in accordance with one or more examples.

FIG. 8 is a flow diagram depicting a process to filter a symbol at a PHY-side of a PHY-MAC interface at least partially based on detecting a predetermined symbol.

FIG. 9 is a flow diagram depicting a process to filter a symbol at a PHY-side of a PHY-MAC interface at least partially based on an indication of out-of-band data, in accordance with one or more examples.

FIG. 10 is a flow diagram depicting process to filter a symbol at a PHY-side of a PHY-MAC interface at least partially based on an indication of valid data and an indication of out-of-band data, in accordance with one or more examples.

FIG. 11 is a flow diagram depicting a process to filter a symbol at a PHY-side of a PHY-MAC interface at least partially based on an indication of valid data, in accordance with one or more examples.

FIG. 12 is a flow diagram depicting a process to filter a symbol at a PHY-side of a PHY-MAC interface at least partially based on detecting a predetermined symbol, an indication of valid data, and an indication of out-of-band data, in accordance with one or more examples.

FIG. 13 depicts timing diagram of signals, in accordance with one or more examples.

FIG. 14 depicts timing diagram of signals, in accordance with one or more examples.

FIG. 15 depicts timing diagram of signals, in accordance with one or more examples.

FIG. 16 is a block diagram of circuitry that, in some examples, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawing could be arranged and designed in a wide variety of different configurations. Thus, the following description of various embodiments is not intended to limit the scope of the present disclosure, but is merely representative of various embodiments. While the various aspects of the embodiments may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

In this description the term “coupled” and derivatives thereof may be used to indicate that two elements co-operate or interact with each other. When an element is described as being “coupled” to another element, then the elements may be in direct physical or electrical contact or there may be intervening elements or layers present. In contrast, when an element is described as being “directly coupled” to another element, then there are no intervening elements or layers present. The terms “on” and “connected” may be used in this description interchangeably with the term “coupled,” and have the same meaning unless expressly indicated otherwise or the context would indicate otherwise to a person having ordinary skill in the art.

As used herein, the term “pin” means “electrical connector,” and should be understood to encompass any structure or device capable of forming at least a portion of an electrical connection, such as an electrical contact, electromechanical device, or a circuit, without limitation.

As used herein, the terms “assert,” “de-assert” and derivatives thereof used in reference to a pin, means, respectively, to assert or de-assert a signal associated with the pin (e.g., a signal specifically assigned to the pin or a signal to which the pin is specifically assigned, without limitation).

A vehicle, such as an automobile, a truck, a bus, a ship, and/or an aircraft, may include a vehicle communication network. The complexity of the vehicle communication network may vary depending on a number of electronic devices within the network. For example, an advanced vehicle communication network may include various control modules for, as non-limiting examples, engine control, transmission control, safety control (e.g., antilock braking), and emissions control. To support these modules, the automotive industry relies on various communication protocols.

10SPE (i.e., 10 Mbps Single Pair Ethernet) is a network technology currently under specification of IEEE 802.3cg™, available from IEEE, Piscataway, New Jersey. 10SPE may be used to provide a collision free, deterministic transmission of symbols on a multi-drop network. The 10SPE specification includes an optional physical level collision avoidance (PLCA) reconciliation sublayer for collision free transmission.

In addition to symbols that are part of “payload data,” a physical layer (PHY) device may receive symbols that are not part of payload data. Payload data is defined as a totality of a frame of data conveyed by a medium access control (MAC) to a PHY for transmission, for example, preamble data, frame data, and integrity data. Payload data is also referred to herein as “in-band data” and with regard to symbols, as “in-band symbols.” Data other than in-band data is also referred to herein as “out-of-band data” and with respect to symbols as “out-of-band symbols.” As a non-limiting example, a PLCA PHY, such as some 10SPE PHYs, that is transmitting may insert symbols used for collision avoidance such as beacon and commit symbols, without limitation.

A media independent interface (MII) may be utilized to couple a MAC with various types of PHYs (i.e., PHYs for connecting to different types of physical media (e.g., coaxial or twisted pair, without limitation) for a transmission medium). An MII typically includes a receive data valid (“rx data valid”) signal that typically indicates symbols of valid received data (in-band data) in the receive data (“rx data”) and a carrier sense signal that typically indicates a detected state (e.g., active or inactive, without limitation) of a carrier on the transmission medium. A MAC can use the rx data valid signal and carrier sense signal to infer which symbols, if any, in the rx data are in-band data.

An MII typically includes a receive error (“rx error”) signal to indicate, together with the rx data valid signal, that specific symbols included in the rx data correspond to out-of-band data. According to 10SPE, when both the rx error signal and the rx data valid signal are de-asserted, that indicates special PLCA symbols are in rx data. In the case of a Carrier Sense Multiple Access (CSMA) MAC or CSMA with collision detect (CSMACD) MAC, the special PLCA symbols are handled by a PLCA reconciliation sublayer in response to the signaling by the rx error signal and rx data valid signal.

An interface wrapper is a logic circuit that can change (e.g., reduce or increase, without limitation) signaling or hardware connections of an interface. Sometimes interface wrappers are utilized to change signaling or a hardware interface between a PHY and a MAC, as a non-limiting example, to reduce the number of connections utilized to couple a PHY and a MAC. As a non-limiting example, a reduced media independent interface (RMII) wrapper may be utilized to wrap an MII and reduce the number of pins (i.e., hardware connections) and signals at the RMII compared to an MII.

A typical RMII wrapper assumes that carrier sense and rx data valid signals are substantially identical, and multiplexes the rx data valid and a carrier sense signals onto a single output (which may also be characterized as an output for non-exclusive signaling of carrier sense and rx data valid signals, or “crs dv”). A typical RMII does not include an rx error signal. In a case where the internal MII carrier sense signal is asserted, the internal MII rx data valid signal is de-asserted, and the internal MII rx error signal is asserted, a typical RMII wrapper will assert the crs dv signal based on at least one of carrier sense and rx data valid signals being asserted. Thus, an RMII wrapper may unintentionally indicate that symbols are in-band data when they are actually out-of-band data. In this same case, when the MAC receives the asserted crs dv signal it may, as a non-limiting example, merge symbols of in-band data and out-of-band data resulting in corrupt data, lost data, or useless data.

The inventors of this disclosure appreciate that it may be advantageous to include symbol filtering at an interface wrapper (e.g., an RMII wrapper, without limitation) to, as a non-limiting example, increase accurate communication of in-band data (e.g., payload data, without limitation) or out-of-band data (e.g., PLCA symbols, without limitation) via a wrapped interface. Use herein of the terms “filter,” “filtering,” or derivatives thereof is not intended to require blocking, masking, or not passing symbols, nor circuits that perform blocking, masking or not passing symbols. Unless explicitly stated otherwise or it would be understood otherwise by a person having ordinary skill in the art based on the context, the terms “filter,” “filtering,” or derivatives thereof should be understood to encompass a variety of techniques, including, but not limited to, passing symbols and modifying or suppressing signals that influence how a downstream user interprets (e.g., as in-band-symbols or out-of-band symbols without limitation), uses, or detects in-band or out-of-band symbols, as well as blocking, masking, or not passing symbol data.

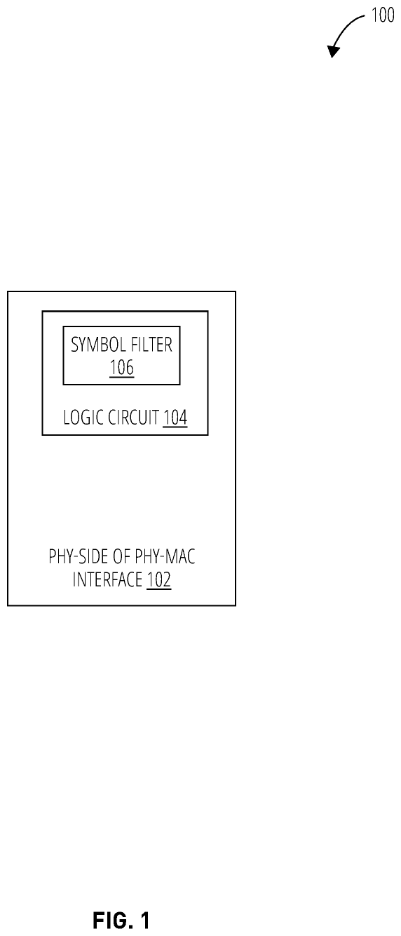

FIG. 1 is a block diagram of an apparatus 100 to filter symbols conveyed from a PHY toward a MAC via a PHY-MAC interface. Apparatus 100 may also be referred to as “an interface portion 100.” Apparatus 100 includes a PHY-side of PHY-MAC interface 102. PHY-side of PHY-MAC interface 102 includes a logic circuit 104, which includes symbol filter 106.

PHY-side of PHY-MAC interface 102 is the PHY portion of an interface to facilitate communication of data (e.g., frames of data, without limitation) between a PHY and a MAC. By way of non-limiting example, a PHY-MAC interface of PHY-side of PHY-MAC interface 102 may be an Ethernet PHY-MAC interface.

Symbol filter 106 of logic circuit 104 is to filter one or more symbols conveyed via PHY-side of PHY-MAC interface 102. In one or more examples, filtered symbols may be predetermined symbols, symbols identified via specific signaling, or both. Non-limiting examples of predetermined symbols include, PLCA symbols such as beacon or commit symbols, or out-of-band symbols more generally. Non-limiting examples of suppressing communication includes dropping predetermined symbols from a data frame or stream, or providing signaling to indicate presence of predetermined symbols or invalid data more generally (which may include providing signaling to indicate non-presence of data or valid data), or combinations thereof. Filtering of symbols other than out-of-band data does not exceed the scope of this disclosure. Any “symbol-to-ignore” may be filtered according to examples disclosed herein, including, in one or more examples, in-band data.

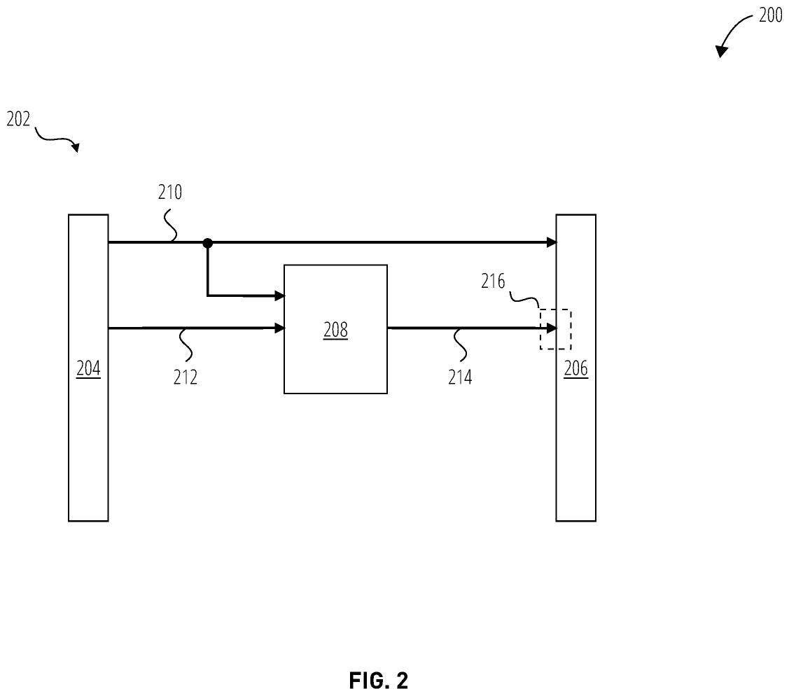

FIG. 2 is a block diagram of a PHY-side of PHY-MAC interface 200 that includes symbol filtering, in accordance with one or more examples. PHY-side of PHY-MAC interface 200 is a non-limiting example of PHY-side of PHY-MAC interface 102 of FIG. 1.

PHY-side of PHY-MAC interface 200 includes interface 204, which may be a PHY-side of an MII, interface wrapper 206, which may be a PHY-side of an RMII wrapper, and symbol filter 208, which collectively form a PHY-side of wrapped interface 202. Symbol filter 208 is provided at input 216 of interface wrapper 206. Input 216 is, generally, to receive state signaling, such as emulated state signaling 214 (which may be the same or different than state signaling 212) generated by symbol filter 208.

Various connections (not shown) may carry signaling and data, including data stream 210 and state signaling 212. Data stream 210 is a data stream of symbols (“symbol data”) received by a PHY from a physical transmission medium. State signaling 212 includes one or more signals to indicate one or more of: a state of a carrier on a physical transmission medium (e.g., state is “active” (i.e., carrying transmit data such as in-band data or out-of-band data, without limitation), or is “inactive” (i.e., not carrying transmit data such as in-band data or out-of-band data, without limitation), without limitation) or a state of symbol data of data stream 210 (e.g., the symbol is in-band data or out-of-band data, without limitation). As discussed, above, downstream users of emulated state signaling 214 to differentiate in-band symbols and out-of-band symbols of a data stream (e.g., among data stream 210, without limitation).

Symbol filter 208 generates emulated state signaling 214 and provides it to interface wrapper 206. Symbol filter 208 may generate emulated state signaling 214 at least partially responsive to one or more of data stream 210 or state signaling 212, as discussed herein. In one or more examples, by implementing differences between instances of emulated state signaling 214 and state signaling 212, symbol filter 208 may influence how a downstream user differentiates between in-band data and out-of-band data among a data stream 210.

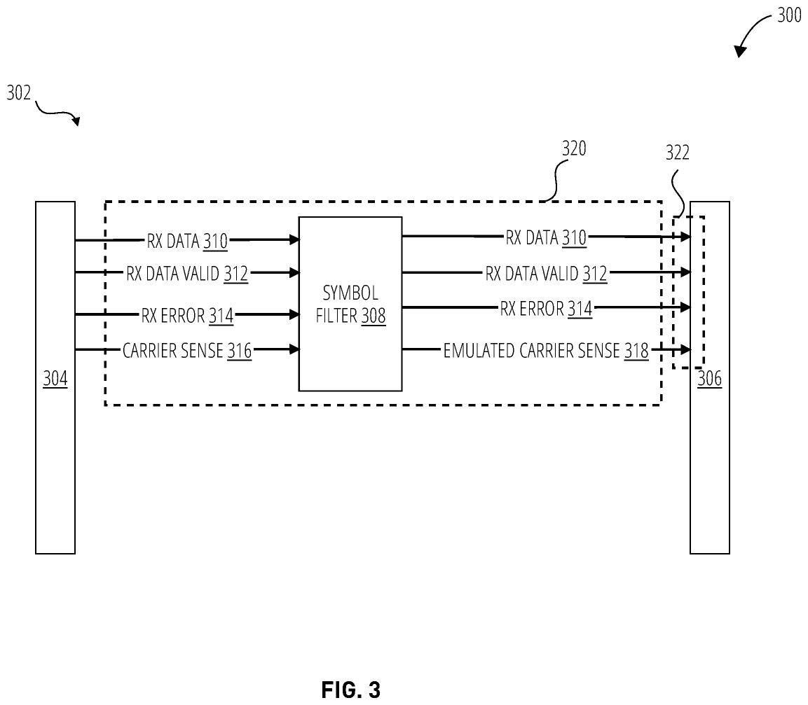

FIG. 3 is a block diagram of an interface portion 300 that includes symbol filtering, in accordance with one or more examples. Interface portion 300 is an example PHY-side of a PHY-MAC interface. FIG. 3 depicts, among other things, a PHY-side of RMII wrapper 306 having symbol-filtered inputs in accordance with one or more examples. Interface portion 300 is a non-limiting example of PHY-side of PHY-MAC interface 102 of FIG. 1 or PHY-side of PHY-MAC interface 200 of FIG. 2.

Interface portion 300 includes a PHY-side of MII 304, PHY-side of RMII wrapper 306, and symbol filter 308 that collectively form PHY-side of RMII 302. Multiple connections couple PHY-side of MII 304 with PHY-side of RMII wrapper 306, including internal connections for signals provided on receive path 320 (i.e., a PHY to MAC data path) of PHY-side of RMII 302. The signals provided on receive path 320 include, without limitation, rx data 310, rx data valid 312, rx error 314 and carrier sense 316.

Rx data 310 is associated with receive data (“rx data”) received by a PHY from a shared transmission medium and conveyed from a PHY toward a MAC, and carries a data stream of symbols (“symbol data”). Rx data valid 312 is associated with an indication of presence of valid data (i.e., symbols that are in-band data) in rx data 310, i.e., with valid data on the internal connections carrying rx data 310. Timing is associated with assertions/de-assertions of the rx data valid 312 signal, so when the rx data valid 312 signal is asserted that indicates a time that valid data is present on the internal connections carrying rx data 310, and when the rx data valid 312 signal is de-asserted that indicates a time valid data is not present on the internal connections carrying rx data 310.

Rx error 314 is associated with an indication of presence of out-of-band data (e.g., predetermined symbols to communicate a state of a link partner or carrier on a cable, without limitation) on the internal connections carrying rx data 310. Timing is associated with assertions/de-assertions of the rx error 314 signal, so when the rx error 314 signal is asserted that indicates a time out-of-band data is present on the internal connections carrying rx data 310, and when the rx error 314 signal is de-asserted that indicates a time out-of-band data is not present on the internal connections carrying rx data 310.

Carrier sense 316 is associated with a detected state of a carrier at a physical medium (e.g., a cable such as a coaxial or twisted pair type cable, without limitation). Non-limiting examples of states of a carrier include “active” and “inactive,” as discussed above.

Symbol filter 308 is arranged between PHY-side of MII 304 and inputs 322 of PHY-side of RMII wrapper 306 to receive signals rx data 310, rx data valid 312, rx error 314 and carrier sense 316. In one or more examples, symbol filter 308 may provide (e.g., propagate or re-drive, without limitation) some or a totality of signals rx data 310, rx data valid 312, rx error 314, and carrier sense 316, toward inputs 322 of PHY-side of RMII wrapper 306 associated with such signals. Symbol filter 308 may generate emulated carrier sense 318 at least partially responsive to one or more of signals rx data 310, rx data valid 312, or rx error 314, as discussed herein. By implementing differences between the received carrier sense 316 signal and the output emulated carrier sense 318 signal, symbol filter 308 may influence how a downstream user (e.g., a MAC, without limitation) differentiates between in-band data and out-of-band data among a data stream on the internal connections carrying rx data 310. The influence on how the downstream user differentiates between in-band data and out-of-band data among a data stream, is termed herein a symbol filtering.

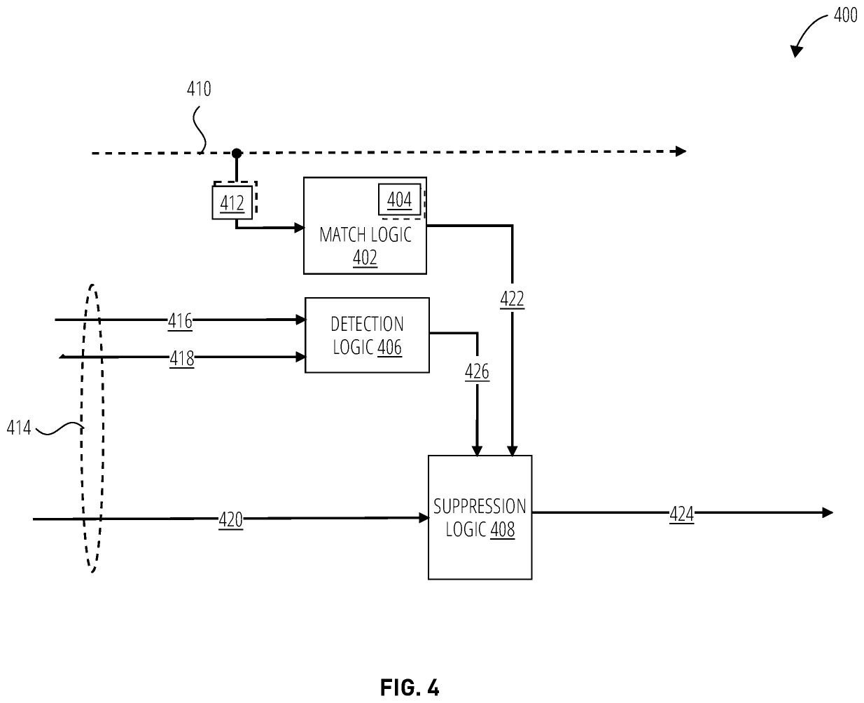

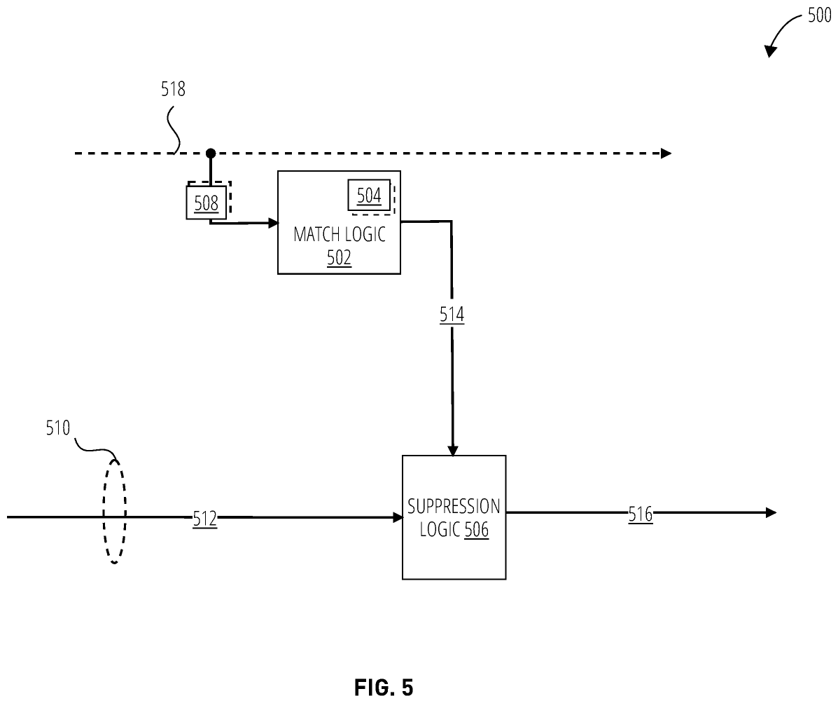

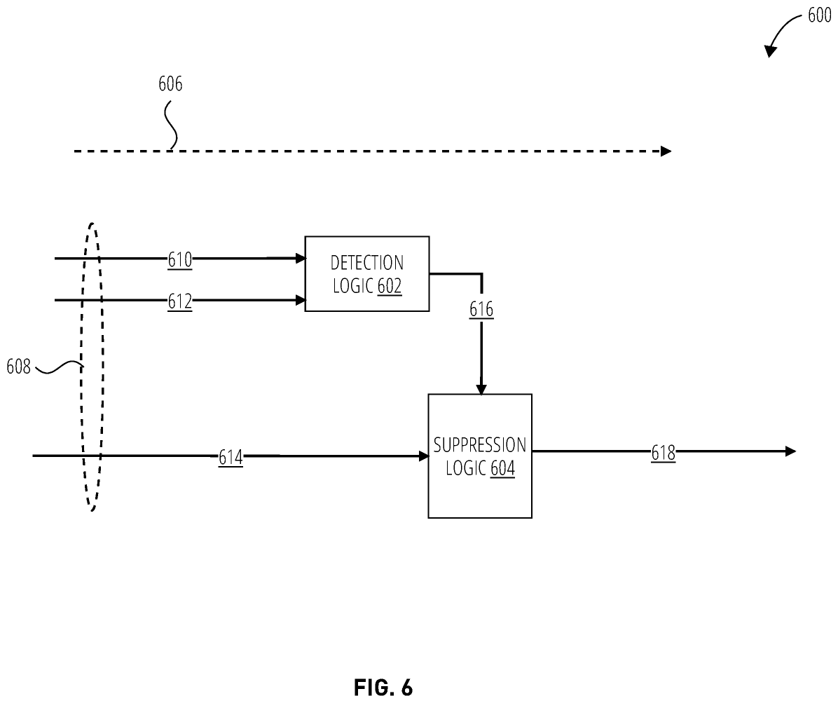

FIG. 4, FIG. 5, and FIG. 6 are block diagrams depicting configurations of symbol filters that are non-limiting examples of symbol filter 208 of FIG. 2, symbol filter 308 of FIG. 3 or symbol filter 106 of logic circuit 104 of FIG. 1.

FIG. 4 is a block diagram depicting a symbol filter 400 to filter at least partially based on detecting: a predetermined symbol, an indication of valid data, and an indication of out-of-band data, in accordance with one or more examples.

Symbol filter 400 includes a match logic 402, a detection logic 406, and a suppression logic 408. Match logic 402 receives data stream 410. Detection logic 406 and suppression logic 408 respectively receive at least some component signals of state signaling 414. The component signals of state signaling 414 received by detection logic 406 include rx error signal 416 and, optionally, valid rx data 418. The component signal of state signaling 414 received by suppression logic 408 includes carrier sense 420.

Match logic 402 detects that one or more symbols 412 of data stream 410 match one or more predetermined symbols 404. As a non-limiting example, predetermined symbols 404 may include predetermined symbols associated with out-of-band data (e.g., predetermined symbols of bits or symbols associated with out-of-band data stored at, or accessible by, match logic 402) such as commit symbols, PLCA symbols, or beacon symbols, without limitation. In response to detecting that a one or more symbols 412 matches one or more predetermined symbols 404, match logic 402 asserts out-of-band symbol indication 422. Assertion of out-of-band symbol indication 422 indicates the presence of one or more predetermined symbols 404 in data stream 410, and de-assertion of out-of-band symbol indication 422 indications non-presence of one or more predetermined symbols 404 in data stream 410.

As a non-limiting example, match logic 402 may be a combinational logic circuit that performs bit-wise comparison of predetermined symbols 404 and symbols 412, generates out-of-band symbol indication 422 exhibiting a first logic level, which may be a high voltage level, in response to the comparison indicating the bits (or a suitable number of the bits) are the same, and exhibiting a second logic level, which may be a low voltage level, in response to the comparison indicating the bits (or a suitable number of the bits) are different.

Detection logic 406 detects that state signaling 414 indicates the presence of out-of-band data at data stream 410. As discussed above with respect to rx error 314, assertion of rx error signal 416 indicates out-of-band data is present in data stream 410. As discussed above with respect to rx data valid 312, de-assertion of rx data valid 312 indicates valid data is not present in data stream 410. Detection logic 406 asserts out-of-band data signaling indication 426 at least partially responsive to detecting both: assertion of rx error signal 416 and de-assertion of valid rx data signal 418. As a non-limiting example, detection logic 406 may be a combinational logic circuit that includes an AND gate having an input coupled to receive rx error signal 416 and an input coupled to receive valid rx data signal 418. In a contemplated operation, the AND gate outputs out-of-band data signaling indication 426 exhibiting a logic high voltage level in response to one or both of rx error signal 416 and valid rx data signal 418 exhibiting a logic high voltage (in a case where logic high voltage level corresponds to asserted and logic low voltage level corresponds to de-asserted), and exhibiting a logic low voltage level otherwise. Suppression logic 408 generates emulated carrier sense 424 to indicate to a downstream user (e.g., a MAC, without limitation) whether or not one or more symbols of data stream 410 correspond to out-of-band data. Suppression logic 408 generates emulated carrier sense 424, which may include signaling to indicate that one or more symbols of data stream 410 correspond to out-of-band data, at least partially responsive to detecting both: assertion of out-of-band symbol indication 422 (indicating one or more symbols 412 matched one or more predetermined symbols 404) and assertion of out-of-band data signaling indication 426 (indicating state signaling 414 indicated presence of out-of-band data at data stream 410). Notably, portions of emulated carrier sense 424 may be different from carrier sense 420, other portions will be substantially the same (i.e., unchanged).

As a non-limiting example, suppression logic 408 may be a combinational logic circuit that includes an AND gate having an input coupled to the output of match logic 402 to receive out-of-band symbol indication 422 and an input coupled to the output of detection logic 406 to receive out-of-band data signaling indication 426, and a NAND gate with an input coupled to the output of the AND gate, and an input coupled to receive carrier sense 420. In a contemplated operation, the AND gate outputs a signal exhibiting a logic high voltage level in response to one or both of out-of-band data signaling indication 426 and out-of-band symbol indication 422 are logic high. Further, the NAND gate outputs emulated carrier sense 424 exhibiting a logic low voltage level in response to carrier sense 420 exhibiting a logic high voltage level and the output of the AND gate exhibiting a logic high voltage level.

FIG. 5 is a block diagram depicting a symbol filter 500 to filter at least partially based on detecting: a predetermined symbol, in accordance with one or more examples.

Symbol filter 500 includes a match logic 502 and a suppression logic 506. Match logic 502 is coupled to receive data stream 518. A component signal of state signaling 510 received by suppression logic 506 includes carrier sense 512.

Match logic 502 detects that one or more symbols 508 of data stream 518 match one or more predetermined symbols 504. As a non-limiting example, one or more predetermined symbols 504 may include predetermined out-of-band data such as PLCA symbols (e.g., beacon symbols or commit symbols), without limitation. In response to detecting that one or more symbols 508 matches one or more predetermined symbols 504, match logic 502 asserts out-of-band symbol indication 514, which assertion indicates presence of out-of-band data at data stream 518.

As a non-limiting example, match logic 502 may be a combinational logic circuit that performs bit-wise comparison of predetermined symbols 504 with symbols 508, and outputs out-of-band symbol indication 514 exhibiting a logic high voltage level in response to the comparison indicating the bits (or a suitable number of the bits) are the same, and exhibiting a logic low voltage level in response to the comparison indicating the bits (or a suitable number of the bits) are different.

Suppression logic 506 generates emulated carrier sense 516 to indicate to a downstream user (e.g., a MAC, without limitation) that one or more symbols of data stream 518 correspond to out-of-band data. Suppression logic 506 generates emulated carrier sense 516, including signaling to indicate that one or more symbols of data stream 518 correspond to out-of-band data, at least partially responsive to detecting assertion of out-of-band symbol indication 514, indicating that one or more symbols 508 match one or more predetermined symbols 504. Notably, in various use cases, portions of emulated carrier sense 516 may be different from carrier sense 512, other portions may be substantially the same (i.e., unchanged).

As a non-limiting example, suppression logic 506 may be a combinational logic circuit that includes a NAND gate having an input coupled to the output of match logic 502 and an input coupled to receive carrier sense 512. In a contemplated operation, the NAND gate outputs emulated carrier sense 516 exhibiting a logic low voltage level in response to both out-of-band data signaling indication 426 and carrier sense 512 exhibiting a logic high voltage level.

FIG. 6 is a block diagram depicting a symbol filter 600 to filter at least partially based on an indication of valid data and an indication of out-of-band data, in accordance with one or more examples.

Symbol filter 600 includes a detection logic 602 and a suppression logic 604. Data stream 606 is depicted by FIG. 6, but is optional as suppression logic 604 relies on out-of-band data signaling indication 616 from detection logic 602, but not direct symbol matching (e.g., match logic 402 or match logic 502, without limitation), to generate emulated carrier sense 618, as discussed herein.

Detection logic 602 and suppression logic 604 respectively receive some of the components signals of state signaling 608. The component signals of state signaling 608 received by detection logic 602 include rx error 610 and, optionally, valid rx data 612. The component signal of state signaling 608 received by suppression logic 604 include carrier sense 614.

Detection logic 602 detects that state signaling 608 indicates the presence of out-of-band data in data stream 606 and asserts or de-asserts out-of-band data signaling indication 616 at least partially in response thereto. As discussed above with respect to rx error 314, assertion of rx error 610 indicates out-of-band data is present at data stream 606. As discussed above with respect to rx data valid 312, de-assertion of valid rx data 612 indicates valid data is not present in data stream 606. Detection logic 602 asserts out-of-band data signaling indication 616 at least partially responsive to detecting assertion of rx error 610 and de-assertion of valid rx data 612. As a non-limiting example, detection logic 602 may be a combinational logic circuit that includes an AND gate having an input coupled to receive rx error 610 and an input coupled to receive an inverted version of valid rx data 612. The AND gate outputs out-of-band data signaling indication 426 exhibiting a logic high voltage level in response to both rx error 610 exhibiting a logic high voltage and the inverted version of valid rx data signal 418 exhibiting a logic low voltage, and outputs out-of-band data signaling indication 426 exhibiting a logic low level otherwise.

Suppression logic 604 generates emulated carrier sense 618 to indicate to a downstream user (e.g., a MAC, without limitation) that one or more symbols of data stream 606 correspond to out-of-band data. Suppression logic 604 generates emulated carrier sense 618, including signaling to indicate that one or more symbols of data stream 606 correspond to out-of-band data, at least partially responsive to detecting assertion of out-of-band data signaling indication 616. Notably, portions of emulated CRS 618 may be different from carrier sense 614, other portions will be substantially the same (i.e., unchanged). As a non-limiting example, suppression logic 604 may be a combinational logic circuit that includes a NAND gate with an input coupled to the output of detection logic 602 and an input coupled to receive carrier sense 614. In a contemplated operation, the NAND gate outputs a logic low voltage level in response to both out-of-band data signaling indication 616 and carrier sense 614 exhibiting a logic high voltage level, and logic high voltage level otherwise.

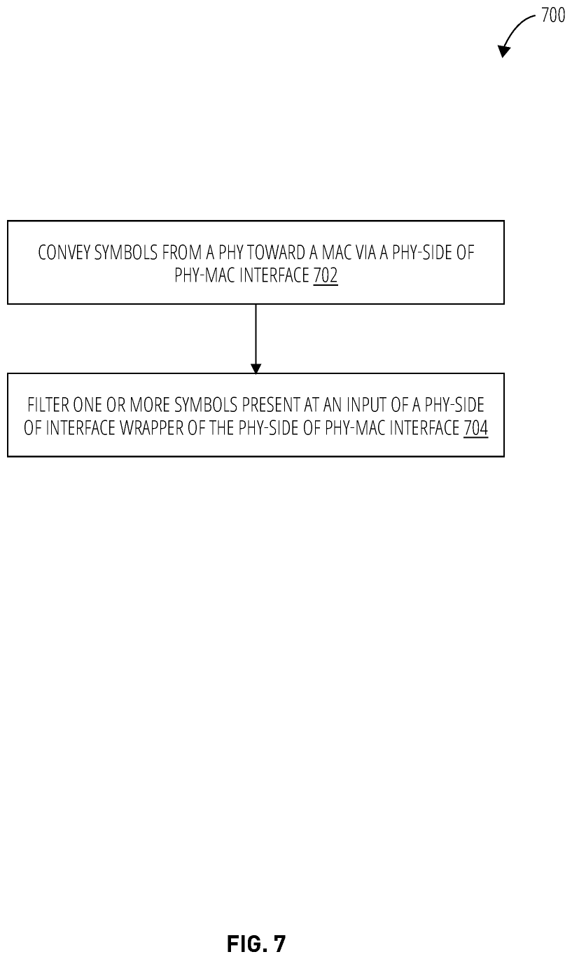

FIG. 7 is a flow diagram depicting a process 700 to filter symbols at a PHY-side of PHY-MAC interface, in accordance with one or more examples. Process 700 may be performed, as a non-limiting example, by apparatus 100 of FIG. 1.

At operation 702, process 700 conveys symbols from a PHY toward a MAC via a PHY-side of PHY-MAC interface. At least some conveyed symbols are out-of-band data or in-band data. Some of the conveyed symbols may be symbols-to-ignore.

At operation 704, process 700 filters one or more symbols at an input of an interface wrapper of the PHY-side of PHY-MAC interface. The interface wrapper may be an RMII wrapper and the PHY-side of PHY-MAC interface may be a wrapped interface, such as an MII wrapped by an RMII, without limitation.

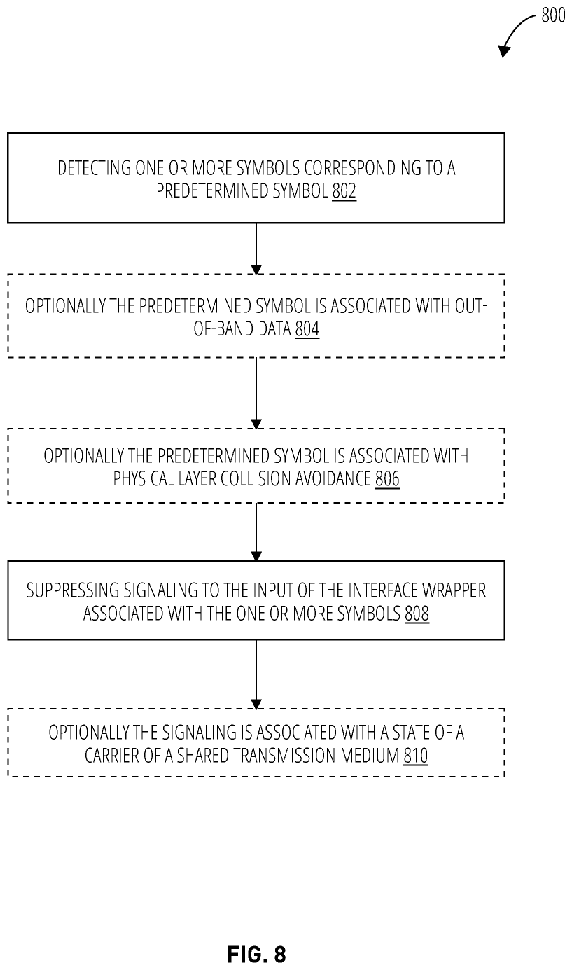

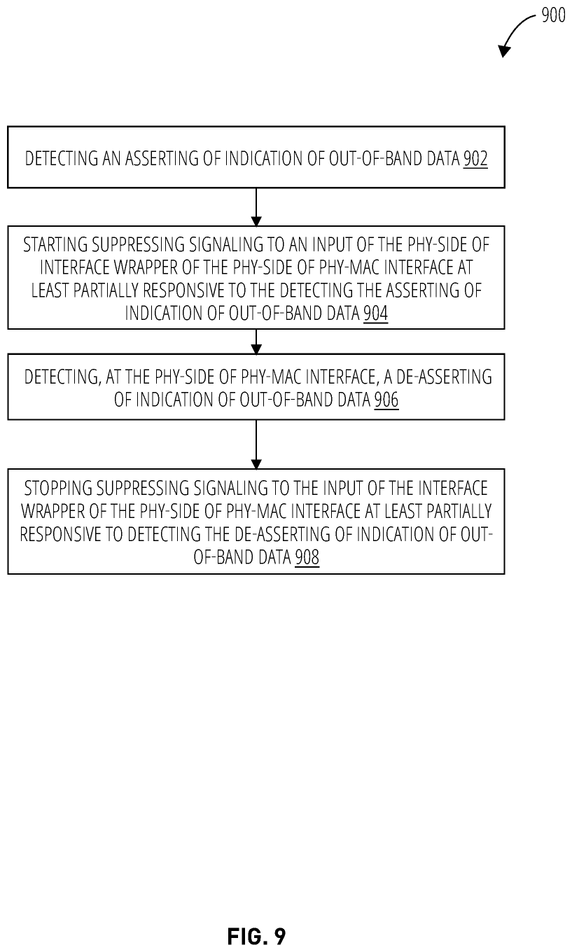

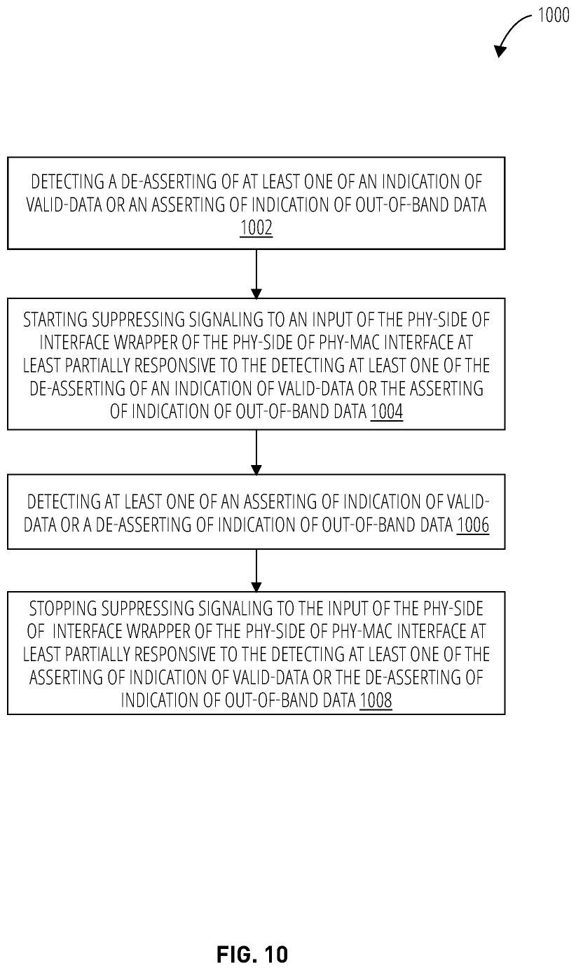

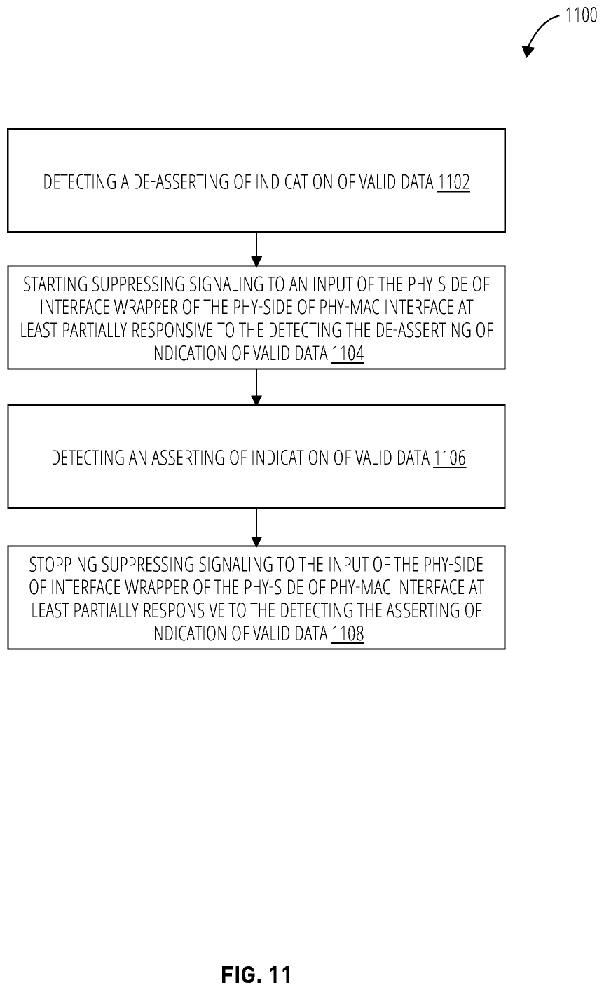

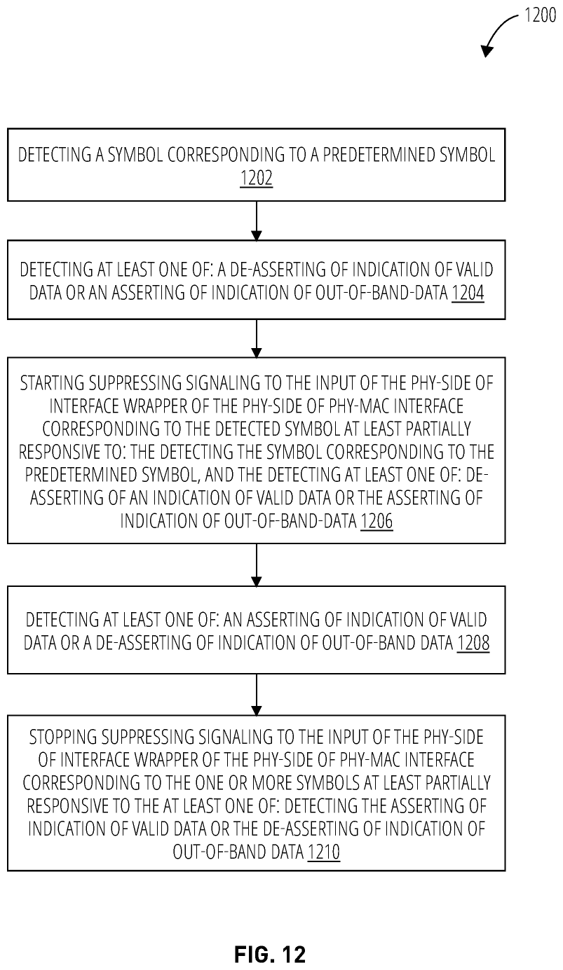

FIG. 8, FIG. 9, FIG. 11, FIG. 10, and FIG. 12 are flow diagrams that respectively depict suppressing signaling at a PHY-side of PHY-MAC interface to filter symbols, in accordance with one or more examples.

FIG. 8 is a flow diagram depicting a process 800 to filter a symbol at a PHY-side of PHY-MAC interface at least partially based on detecting a predetermined symbol. Process 800 may be performed, as a non-limiting example, by symbol filter 500 at PHY-side of PHY-MAC interface 200 or PHY-side of PHY-MAC interface 102.

At operation 802, process 800 detects one or more symbols corresponding to a predetermined symbol. Correspondence between the one or more symbols and the predetermined symbols may be detected at an input to a PHY-side of interface wrapper of a PHY-side of PHY-MAC interface.

In operation 804, optionally the predetermined symbol is associated with out-of-band data (e.g., predetermined symbols of bits or symbols associated with commit symbols, PLCA symbols, beacon symbols, or other out-of-band data stored at, or accessible by, match logic 502). In operation 806, optionally the predetermined symbol is associated with physical layer collision avoidance (PLCA).

At operation 808, process 800 suppresses signaling to the input of the PHY-side of interface wrapper of the PHY-side of PHY-MAC interface, the signaling associated with the one or more symbols. As a non-limiting example, signaling to the input of the PHY-side of interface wrapper of the PHY-side of PHY-MAC interface may be suppressed during a same time duration that associated symbols are provided to the PHY-side of interface wrapper of the PHY-side of PHY-MAC interface.

At operation 810, optionally the signaling which is suppressed is associated with a state of a carrier of a shared transmission medium.

FIG. 9 is a flow diagram depicting a process 900 to filter a symbol at a PHY-side of PHY-MAC interface at least partially based on an indication of out-of-band data such as assertion of rx error 610 of FIG. 6, in accordance with one or more examples.

At operation 902, process 900 detects an asserting of indication of out-of-band data, e.g., by assertion of out-of-band data signaling indication 616. The asserting may be detected in response to the indication of out-of-band data changing state from de-asserted to asserted.

At operation 904, process 900 starts suppressing signaling to an input of the PHY-side of interface wrapper of the PHY-side of PHY-MAC interface at least partially responsive to detecting the asserting of the indication of out-of-band data. Suppressing signaling may include providing signaling to indicate presence of predetermined symbols or invalid data more generally (which may include providing signaling to indicate non-presence of data or valid data), or combinations thereof.

At operation 906, process 900 detects a de-asserting of indication of out-of-band data. The de-asserting may be detected in response to the indication of out-of-band data changing state from asserted to de-asserted.

At operation 908, process 900 stops suppress signaling to an input of the PHY-side of interface wrapper of the PHY-side of PHY-MAC interface at least partially responsive to detecting the de-asserting of indication of out-of-band data.

FIG. 10 is a flow diagram depicting a process 1000 to filter a symbol at a PHY-side of PHY-MAC interface at least partially based on an indication of valid data such as valid rx data 612 of FIG. 6 and an indication of out-of-band data such as rx error 610 of FIG. 6, in accordance with one or more examples.

At operation 1002, process 1000 detects at least one of: a de-asserting of an indication of valid data (e.g., de-asserting of valid rx data 612 of FIG. 6, without limitation) or an asserting of indication of out-of-band data (e.g., asserting of rx error 610 of FIG. 6, without limitation). The de-asserting of the indication of valid data may be detected in response to the indication of valid data (e.g., valid rx data 612, without limitation) changing state from asserted to de-asserted, and the asserting of indication of out-of-band data (e.g., rx error 610, without limitation) may be detected in response to the indication of out-of-band data changing state from de-asserted to asserted.

At operation 1004, process 1000 starts suppressing signaling (e.g., carrier sense 614 of FIG. 6, without limitation) to an input of the PHY-side of interface wrapper of the PHY-side of PHY-MAC interface at least partially responsive to the detecting at least one of: the de-asserting of an indication of valid data or the asserting of indication of out-of-band data.

At operation 1006, process 1000 detects at least one of: an asserting of indication of valid data or a de-asserting of indication of out-of-band data. The asserting of indication of valid data may be detected in response to the indication of valid data changing state from de-asserted to asserted, and the de-asserting of indication of out-of-band data may be detected in response to the indication of out-of-band data changing state from asserted to de-asserted.

At operation 1008, process 1000 stops suppressing signaling to an input of the PHY-side of interface wrapper of the PHY-side of PHY-MAC interface at least partially responsive to the detecting at least one of: the asserting of indication of valid data or the de-asserting of indication of out-of-band data.

FIG. 11 is a flow diagram depicting a process 1100 to filter a symbol at a PHY-side of PHY-MAC interface at least partially based on an indication of valid data such as valid rx data 612 of FIG. 6, in accordance with one or more examples.

At operation 1102, process 1100 detects a de-asserting of indication of valid data. The de-asserting may be detected in response to the indication of valid data changing state from asserted to de-asserted.

At operation 1104, process 1100 starts suppressing signaling at the PHY-side of PHY-MAC interface at least partially responsive to the detecting de-asserting of indication of valid data.

At operation 1106, process 1100 detects, at the PHY-side of PHY-MAC interface, an asserting of indication of valid data. The asserting may be detected in response to the indication of valid data changing state from de-asserted to asserted.

At operation 1108, process 1100 stops suppressing signaling at the PHY-side of PHY-MAC interface at least partially responsive to the detecting the asserting of indication of valid data.

FIG. 12 is a flow diagram depicting a process 1200 to filter a symbol at a PHY-side of PHY-MAC interface at least partially based on detecting a predetermined symbol (e.g., predetermined symbol 404, without limitation), an indication of valid data (e.g., valid rx data 418 of FIG. 4, without limitation), and an indication of out-of-band data (e.g., rx error signal 416 of FIG. 4, without limitation), in accordance with one or more examples.

At operation 1202, process 1200 detects a symbol corresponding to a predetermined symbol.

At operation 1204, process 1200 detects at least one of: a de-asserting of indication of valid data or an asserting of indication of out-of-band data. The de-asserting may be detected in response to the indication of valid data changing state from asserted to de-asserted, and the asserting may be detected in response to the indication of out-of-band data changing state from de-asserted to asserted.

At operation 1206, starting suppressing signaling at input of the PHY-side of interface wrapper of the PHY-side of PHY-MAC interface corresponding to the detected symbol at least partially responsive to the detecting the symbol corresponding to the predetermined symbol, and the detecting at least one of: de-asserting of an indication of valid data or the asserting of indication of out-of-band data.

At operation 1208, detecting at least one of: an asserting of indication of valid data or a de-asserting of indication of out-of-band data. The asserting may be detected in response to the indication of valid data changing state from de-asserted to asserted, and the de-asserting may be detected in response to the indication of out-of-band data changing state from asserted to de-asserted.

At operation 1210, stopping suppressing signaling at the input of the PHY-side of interface wrapper of the PHY-side of PHY-MAC interface corresponding to the one or more symbols at least partially responsive to the at least one of: detecting the asserting of indication of valid data or the de-asserting of indication of out-of-band data.

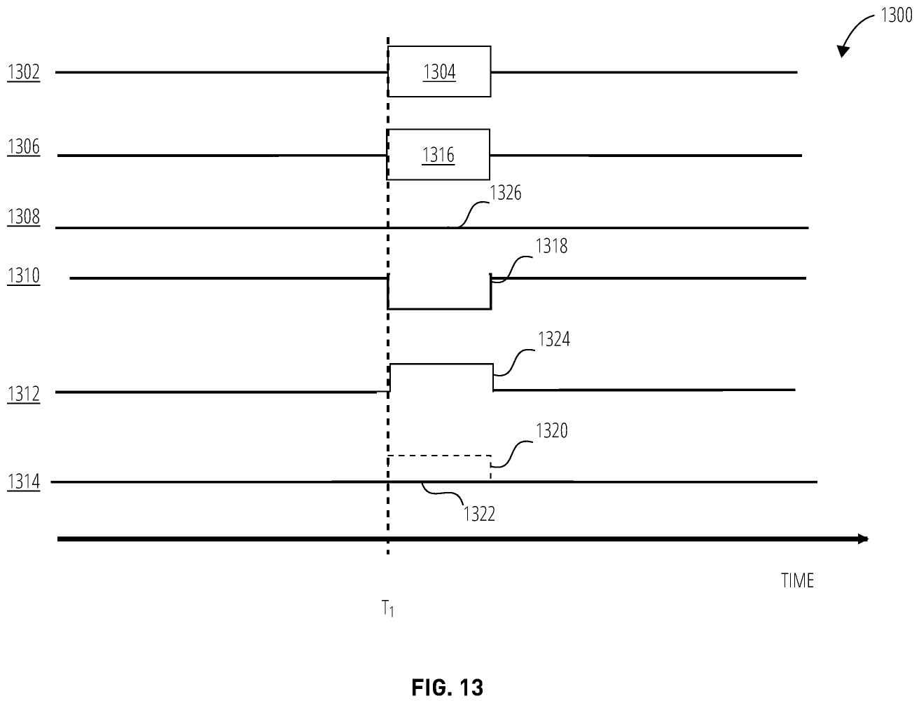

FIG. 13 depicts a timing diagram 1300 of signals, in accordance with one or more examples. Timing diagram 1300 depicts signals on cable 1302 (i.e., a transmission medium from which a PHY receives symbols), and respective signals: rx data 1306, valid rx data 1308, rx error 1310, carrier sense 1312, and emulated carrier sense 1314.

At time T₁, a symbol-to-ignore 1304 is present at cable 1302 and represented as symbol-to-ignore 1316 on rx data 1306. Valid rx data 1308 is de-asserted 1326 at time T₁ because no valid data is present at rx data 1306. Rx error 1310 is de-asserted 1318 at time T₁ because, in this example, the symbol-to-ignore is special data (e.g., a commit symbol or beacon, without limitation). Carrier sense 1312 is asserted 1324 because the carrier is active at cable 1302. Emulated carrier sense 1314 is de-asserted 1322 at time T₁. Accordingly, the signaling by the carrier sense 1312 is suppressed at emulated carrier sense 1314 at time T₁ (dashed line is to illustrate that signaling from carrier sense 1312 is suppressed (in this specific example, not present) at emulated carrier sense 1314), according to any of the logic discussed above: symbol-to-ignore 1304 is detected, valid rx data 1308 is not asserted, rx error 1310 is de-asserted 1318, or combinations thereof.

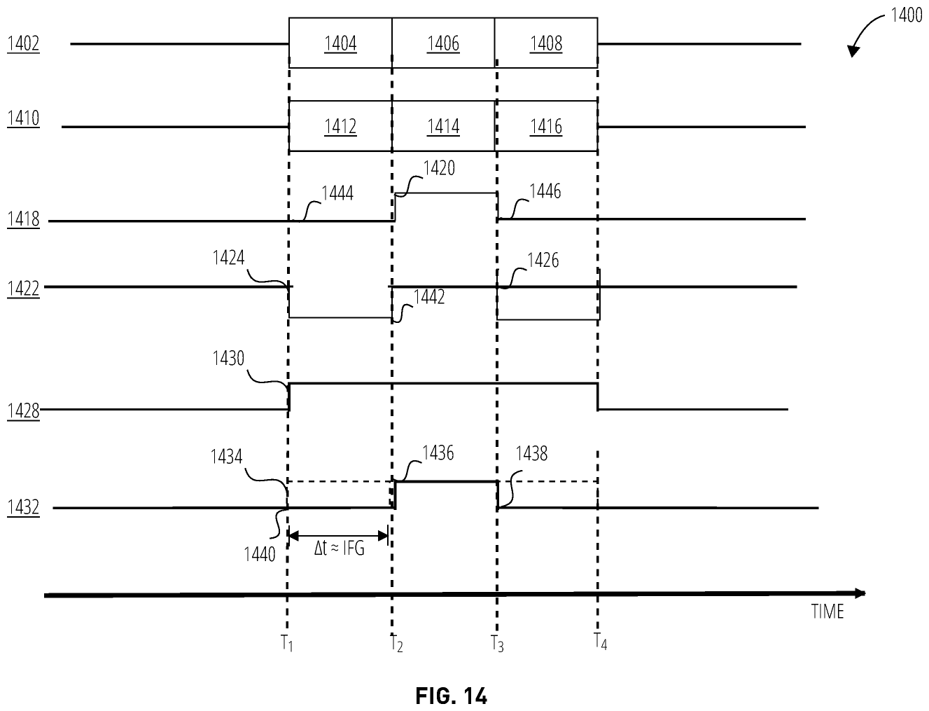

FIG. 14 depicts a timing diagram 1400 of signals, in accordance with one or more examples. Timing diagram 1400 depicts respective signals on: cable 1402, rx data 1410, valid rx data 1418, rx error 1422, carrier sense 1428, and emulated carrier sense 1432.

At time T₁, first symbol-to-ignore 1404 is present at cable 1402, which is represented as first symbol-to-ignore 1412 on rx data 1410. Valid rx data 1418 is not asserted (i.e., de-asserted 1444) at time T₁ because no valid data is present at rx data 1410. Rx error 1422 is de-asserted 1424 at time T₁ because, in this example, the symbol-to-ignore is special data (e.g., a commit symbol or beacon). Carrier sense 1428 is asserted 1430 at time T₁ because an active carrier is present at cable 1402. Emulated carrier sense 1432 is de-asserted 1440 at time T₁. Thus, signaling at carrier sense 1428 is suppressed 1434 at emulate carrier sense 1432 at time T₁ (dashed line is to illustrate that signal on emulated carrier sense 1432 is suppressed), according to any of the logic discussed above: first symbol-to-ignore 1404 is detected, valid rx data 1418 is not asserted, rx error 1422 is de-asserted, or combinations thereof.

At time T₂, symbol data 1406 is present at cable 1402, which is represented as symbol data 1414 on rx data 1410. Valid rx data 1418 is asserted 1420 at time T₂ because valid data is present at rx data 1410. Rx error 1422 is asserted 1442 at time T₂ because, in this example, symbol data 1406 is not special data. Carrier sense 1428 is asserted 1430 at time T₁ because the carrier is active at cable 1402. Emulated carrier sense 1432 is asserted 1436 at time T₂. Thus, signaling of carrier sense 1428 is un-suppressed (not suppressed), which may also be characterized as faithfully propagating signals on carrier sense 1428 (e.g., carrier on emulated carrier sense 1432 at time T₂).

At time T3, second symbol-to-ignore 1408 is present at cable 1402, which is represented as second symbol-to-ignore 1416 on rx data 1410. Valid rx data 1418 is de-asserted 1446 at time T3, because no valid data is present at rx data 1410. Rx error 1422 is de-asserted 1426 at time T3, because, in this example, symbol data 1406 is not special data. Emulated carrier sense 1432 is de-asserted 1438 at time T3. Thus, signaling at carrier sense 1428 is suppressed at emulated carrier sense 1432 at time T3 (dashed line is to illustrate that signal on carrier sense 1428 is suppressed on emulated carrier sense 1432), according to any of the logic discussed above: second symbol-to-ignore 1416 is detected, valid rx data 1418 is not asserted, rx error 1422 is de-asserted 1426, or combinations thereof.

In some cases, filtering of symbols-to-ignore by suppressing signaling at carrier sense 1428 in accordance with one or more examples may create or increase an interframe gap (IFG) between frames of in-band symbols from the perspective of a MAC that receives emulated carrier sense signal 1432. If a frame of an out-of-band symbol is indicated as a frame of an in-band symbol, and the gap between the frame of the out-of-band symbol and an immediately previous or subsequent frame, may be less than an IFG, then a MAC may incorrectly handle one or a totality of the frames. For example, disclosed filtering of first symbol-to-ignore 1412 has the effect of increasing the IFG between a frame of symbol data 1414 and a frame that immediately preceded the frame of first symbol-to-ignore 1412. The time between T₁ and T₂ (ΔT) may be characterized as the IFG, or at least a portion of the IFG, between a frame of symbol data 1414 and a frame that immediately preceded the frame of first symbol-to-ignore 1412. Some examples relate, generally, to guaranteeing a size of IFG. Accordingly, in one or more examples, disclosed symbol filtering and suppressing may guarantee a size of interframe gap.

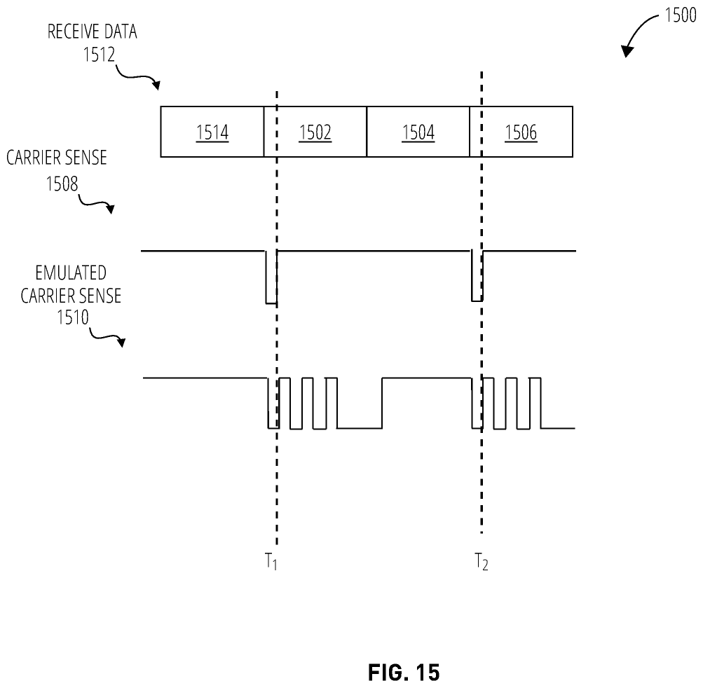

FIG. 15 depicts timing diagram 1500 of signals, in accordance with one or more examples. Timing diagram depicts signals for carrier sense 1508, emulated carrier sense 1510, and receive data 1512.

Carrier sense 1508 is asserted at time T₁ and remains asserted so first symbol-to-ignore 1502 would be appended to in-band data 1514 received by a MAC. Similarly, carrier sense 1508 is asserted at time T₂ and remains asserted so second symbol-to-ignore 1506 would be appended to in-band data 1504. Emulated carrier sense 1510 is asserted at time T₂ but does not remain asserted so first symbol-to-ignore 1502 is not appended to in-band data 1514 received by a MAC. Emulated carrier sense 1510 is asserted at time T₂ but does not remain asserted so second symbol-to-ignore 1506 is not appended to in-band data 1504.

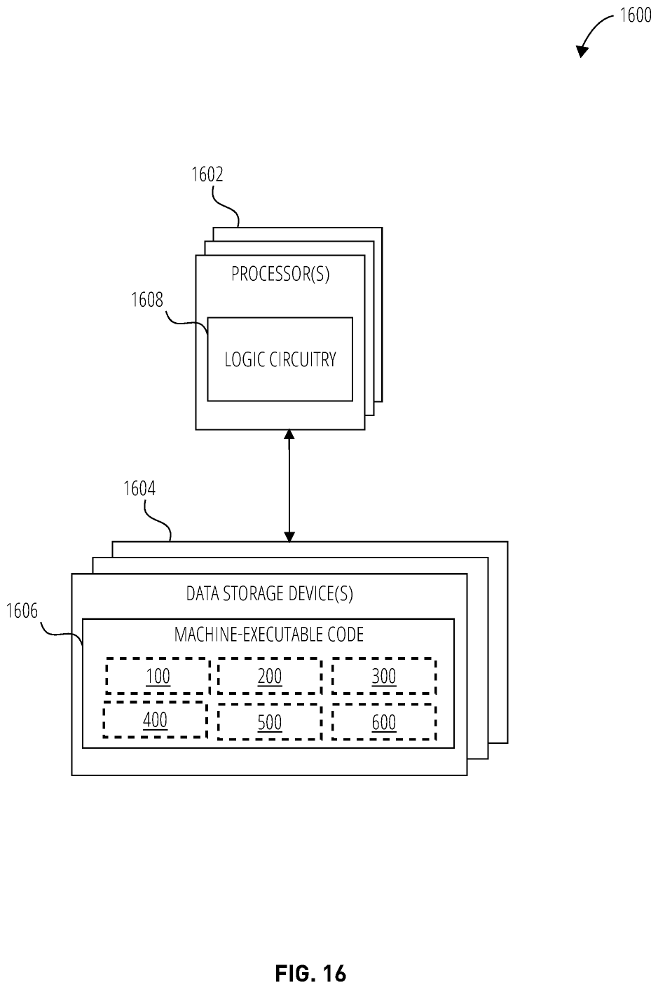

It will be appreciated by those of ordinary skill in the art that functional elements of examples disclosed herein (e.g., functions, operations, acts, processes, and/or methods) may be implemented in any suitable hardware, software, firmware, or combinations thereof. FIG. 16 illustrates non-limiting examples of implementations of functional elements disclosed herein. In some examples, some or all portions of the functional elements disclosed herein may be performed by hardware specially configured for carrying out the functional elements.

FIG. 16 is a block diagram of circuitry 1600 that, in some examples, may be used to implement various functions, operations, acts, processes, and/or methods disclosed herein. The circuitry 1600 includes one or more processors 1602 (sometimes referred to herein as “processors 1602”) operably coupled to one or more data storage devices (sometimes referred to herein as “storage 1604”). The storage 1604 includes machine-executable code 1606 stored thereon and the processors 1602 include logic circuitry 1608. The machine-executable code 1606 includes information describing functional elements that may be implemented by (e.g., performed by) the logic circuitry 1608. The logic circuitry 1608 is adapted to implement (e.g., perform) the functional elements described by the machine-executable code 1606. The circuitry 1600, when executing the functional elements described by the machine-executable code 1606, should be considered as special purpose hardware configured for carrying out functional elements disclosed herein. In some examples the processors 1602 may be configured to perform the functional elements described by the machine-executable code 1606 sequentially, concurrently (e.g., on one or more different hardware platforms), or in one or more parallel process streams.

When implemented by logic circuitry 1608 of the processors 1602, the machine-executable code 1606 is configured to adapt the processors 1602 to perform operations of examples disclosed herein. By way of non-limiting example, the machine-executable code 1606 may be configured to adapt the processors 1602 to perform some or a totality of operations of one or more of: process 700, process 800, process 900, process 1000, process 1100, process 1200, timing diagram 1300, timing diagram 1400, or timing diagram 1500.

Also by way of non-limiting example, the machine-executable code 1606 may be configured to adapt the processors 1602 to perform some or a totality of features, functions, or operations disclosed herein for one or more of: apparatus 100, PHY-side of PHY-MAC interface 200, interface portion 300, symbol filter 400, symbol filter 500, or symbol filter 600. More specifically, features, functions, or operations disclosed herein for one or more of PHY-side of PHY-MAC interface 102, logic circuit 104, or symbol filter 106; interface 204, interface wrapper 206, or symbol filter 208; PHY-side of MII 304, PHY-side of RMII wrapper 306, or symbol filter 308; match logic 402, detection logic 406, or suppression logic 408; match logic 502 or suppression logic 506; or detection logic 602 or suppression logic 604.

The processors 1602 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer is configured to execute functional elements corresponding to the machine-executable code 1606 (e.g., software code, firmware code, hardware descriptions) related to examples of the present disclosure. It is noted that a general-purpose processor (may also be referred to herein as a host processor or simply a host) may be a microprocessor, but in the alternative, the processors 1602 may include any conventional processor, controller, microcontroller, or state machine. The processors 1602 may also be implemented as a combination of computing devices, such as a combination of a DSP and a microprocessor, a plurality of microprocessors, one or more microprocessors in conjunction with a DSP core, or any other such configuration.

In some examples, the storage 1604 includes volatile data storage (e.g., random-access memory (RAM)), non-volatile data storage (e.g., Flash memory, a hard disc drive, a solid state drive, erasable programmable read-only memory (EPROM), etc.). In some examples the processors 1602 and the storage 1604 may be implemented into a single device (e.g., a semiconductor device product, a system on chip (SOC), etc.). In some examples the processors 1602 and the storage 1604 may be implemented into separate devices.

In some examples, the machine-executable code 1606 may include computer-readable instructions (e.g., software code, firmware code). By way of non-limiting example, the computer-readable instructions may be stored by the storage 1604, accessed directly by the processors 1602, and executed by the processors 1602 using at least the logic circuitry 1608. Also by way of non-limiting example, the computer-readable instructions may be stored on the storage 1604, transferred to a memory device (not shown) for execution, and executed by the processors 1602 using at least the logic circuitry 1608. Accordingly, in some examples the logic circuitry 1608 includes electrically configurable logic circuitry 1608.

In some examples, the machine-executable code 1606 may describe hardware (e.g., circuitry) to be implemented in the logic circuitry 1608 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog, SystemVerilog or very large scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuitry 1608 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples the machine-executable code 1606 may include an HDL, an RTL, a GL description, a mask level description, other hardware description, or any combination thereof.

In examples where the machine-executable code 1606 includes a hardware description (at any level of abstraction), a system (not shown, but including the storage 1604) may be configured to implement the hardware description described by the machine-executable code 1606. By way of non-limiting example, the processors 1602 may include a programmable logic device (e.g., an FPGA or a PLC) and the logic circuitry 1608 may be electrically controlled to implement circuitry corresponding to the hardware description into the logic circuitry 1608. Also by way of non-limiting example, the logic circuitry 1608 may include hard-wired logic manufactured by a manufacturing system (not shown, but including the storage 1604) according to the hardware description of the machine-executable code 1606.

Regardless of whether the machine-executable code 1606 includes computer-readable instructions or a hardware description, the logic circuitry 1608 is adapted to perform the functional elements described by the machine-executable code 1606 when implementing the functional elements of the machine-executable code 1606. It is noted that although a hardware description may not directly describe functional elements, a hardware description indirectly describes functional elements that the hardware elements described by the hardware description are capable of performing.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.,” or “one or more of A, B, and C, etc.,” is used, in general such a construction is intended to include A alone, B alone, C alone, A and B together, A and C together, B and C together, or A, B, and C together, etc. As used herein, “each” means some or a totality, and “each and every” means a totality.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting examples of the present disclosure include:

Example 1: A method, comprising: conveying symbols from a PHY toward a MAC via a PHY-side of PHY-MAC interface; and filtering one or more symbols at an input of a PHY-side of interface wrapper of the PHY-side of PHY-MAC interface.

Example 2: The method according to Example 1, wherein filtering one or more symbols present at the input of the PHY-side of interface wrapper of the PHY-side of PHY-MAC interface comprises: detecting a symbol corresponding to a predetermined symbol; and suppressing signaling to the input of the PHY-side of interface wrapper associated with the symbol.

Example 3: The method according to any of Examples 1 and 2, wherein the predetermined symbol is associated with out-of-band data.

Example 4: The method according to any of Examples 1 through 3, wherein the predetermined symbol is associated with physical layer collision avoidance.

Example 5: The method according to any of Examples 1 through 4, wherein the signaling is associated with a state of a carrier of a shared transmission medium.

Example 6: The method according to any of Examples 1 through 5, wherein filtering one or more symbols present at the input of the PHY-side of interface wrapper of the PHY-side of PHY-MAC interface comprises: detecting an asserting of indication of out-of-band data; starting suppressing signaling at the input of the PHY-side of interface wrapper of the PHY-side of PHY-MAC interface at least partially responsive to the detecting the asserting of indication of out-of-band data; detecting a de-asserting of indication of out-of-band data; and stopping suppressing signaling at the input of the PHY-side of interface wrapper of the PHY-side of PHY-MAC interface at least partially responsive to the detecting the de-asserting of indication of out-of-band data.

Example 7: The method according to any of Examples 1 through 6, wherein filtering one or more symbols present at the input of the PHY-side of interface wrapper of the PHY-side of PHY-MAC interface comprises: detecting a de-asserting of indication of valid data; starting suppressing signaling at the input of the PHY-side of interface wrapper of the PHY-side of PHY-MAC interface at least partially responsive to the detecting the de-asserting of indication of valid data; detecting an asserting of indication of valid data; and stopping suppressing signaling at the input of the PHY-side of interface wrapper of the PHY-side of PHY-MAC interface at least partially responsive to the detecting the asserting of indication of valid data.

Example 8: The method according to any of Examples 1 through 7, wherein filtering one or more symbols present at the input of the PHY-side of interface wrapper of the PHY-side of PHY-MAC interface comprises: detecting a de-asserting of an indication of valid data and an asserting of indication of out-of-band data; starting suppressing signaling at the input of the PHY-side of interface wrapper of the PHY-side of PHY-MAC interface at least partially responsive to the detecting the de-asserting of indication of valid data and the asserting of indication of out-of-band data; detecting an asserting of indication of valid data and a de-asserting of indication of out-of-band data; and stopping suppressing signaling at the input of the PHY-side of interface wrapper of the PHY-side of PHY-MAC interface at least partially responsive to the detecting the asserting of indication of valid data and the de-asserting of indication of out-of-band data.

Example 9: The method according to any of Examples 1 through 8, wherein filtering one or more symbols present at an input of a PHY-side of interface wrapper of the PHY-side of PHY-MAC interface comprises: detecting a symbol corresponding to a predetermined symbol; detecting at least one of: a de-asserting of an indication of valid data or an asserting of indication of out-of-band data; starting suppressing signaling at the input of the PHY-side of interface wrapper of the PHY-side of PHY-MAC interface corresponding to the symbol at least partially responsive to the detecting at least one of: de-asserting of indication of valid data or the asserting of indication of out-of-band data; detecting at least one of: an asserting of indication of valid data or a de-asserting of indication of out-of-band data; and stopping suppressing signaling at the input of the PHY-side of interface wrapper of the PHY-side of PHY-MAC interface corresponding to the symbol at least partially responsive to at least one of: detecting the asserting of indication of valid data or the de-asserting of indication of out-of-band data.

Example 10: An apparatus, comprising: a PHY-side of PHY-MAC interface; and a logic circuit provided at the PHY-side of PHY-MAC interface, the logic circuit including a filter to filter one or more symbols conveyed via the PHY-side of PHY-MAC interface.

Example 11: The apparatus according to Example 10, wherein the PHY-side of PHY-MAC interface comprises: a PHY-side of interface; and a PHY-side of interface wrapper, wherein the filter is coupled to filter an input of the PHY-side of interface wrapper.

Example 12: The apparatus according to any of Examples 10 and 11, wherein the filter to filter one or more symbols at least partially responsive to detection of out-of-band data.

Example 13: The apparatus according to any of Examples 10 through 12, wherein the filter comprises: a detection logic to detect one or both of: assertion of indication of out-of-band data or de-assertion of indication of valid data; a match logic to detect a symbol corresponds to a predetermined symbol; and a suppression logic to suppress signaling at the input of the PHY-side of interface wrapper of the PHY-side of PHY-MAC interface at least partially responsive to detection by the detection logic and detection by the match logic.

Example 14: The apparatus according to any of Examples 10 through 13, wherein suppressed signaling is associated with a detected carrier state of a shared transmission medium.

Example 15: The apparatus according to any of Examples 10 through 14, wherein the filter comprises: a match logic to detect a symbol corresponds to a predetermined symbol; and a suppression logic to suppress signaling at the input of the PHY-side of interface wrapper of the PHY-side of PHY-MAC interface at least partially responsive to detection by the match logic.

Example 16: The apparatus according to any of Examples 10 through 15, wherein the filter comprises: a detection logic to detect one or both of: assertion of indication of out-of-band data or assertion of indication of valid data; and a suppression logic to suppress signaling at the input of the PHY-side of interface wrapper of the PHY-side of PHY-MAC interface at least partially responsive to detection by the detection logic.

Example 17: The apparatus according to any of Examples 10 through 16, wherein the PHY-side of interface wrapper is a reduced media independent interface wrapper.

Example 18: The apparatus according to any of Examples 10 through 17, wherein a filtered symbol is a physical layer collision avoidance symbol.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. A method, comprising:
conveying symbols from a PHY toward a MAC via a PHY-side of PHY-MAC interface; and
filtering one or more symbols at an input of a PHY-side of interface wrapper of the PHY-side of PHY-MAC interface.

2. The method of claim 1, wherein filtering one or more symbols present at the input of the PHY-side of interface wrapper of the PHY-side of PHY-MAC interface comprises:
detecting a symbol corresponding to a predetermined symbol; and
suppressing signaling to the input of the PHY-side of interface wrapper associated with the symbol.

3. The method of claim 2, wherein the predetermined symbol is associated with out-of-band data.

4. The method of claim 2, wherein the predetermined symbol is associated with physical layer collision avoidance.

5. The method of claim 2, wherein the signaling is associated with a state of a carrier of a shared transmission medium.

6. The method of claim 1, wherein filtering one or more symbols present at the input of the PHY-side of interface wrapper of the PHY-side of PHY-MAC interface comprises:
detecting an asserting of indication of out-of-band data;
starting suppressing signaling at the input of the PHY-side of interface wrapper of the PHY-side of PHY-MAC interface at least partially responsive to the detecting the asserting of indication of out-of-band data;
detecting a de-asserting of indication of out-of-band data; and
stopping suppressing signaling at the input of the PHY-side of interface wrapper of the PHY-side of PHY-MAC interface at least partially responsive to the detecting the de-asserting of indication of out-of-band data.

7. The method of claim 1, wherein filtering one or more symbols present at the input of the PHY-side of interface wrapper of the PHY-side of PHY-MAC interface comprises:
detecting a de-asserting of indication of valid data;
starting suppressing signaling at the input of the PHY-side of interface wrapper of the PHY-side of PHY-MAC interface at least partially responsive to the detecting the de-asserting of indication of valid data;
detecting an asserting of indication of valid data; and
stopping suppressing signaling at the input of the PHY-side of interface wrapper of the PHY-side of PHY-MAC interface at least partially responsive to the detecting the asserting of indication of valid data.

8. The method of claim 1, wherein filtering one or more symbols present at the input of the PHY-side of interface wrapper of the PHY-side of PHY-MAC interface comprises:
detecting a de-asserting of an indication of valid data and an asserting of indication of out-of-band data;
starting suppressing signaling at the input of the PHY-side of interface wrapper of the PHY-side of PHY-MAC interface at least partially responsive to the detecting the de-asserting of indication of valid data and the asserting of indication of out-of-band data;
detecting an asserting of indication of valid data and a de-asserting of indication of out-of-band data; and
stopping suppressing signaling at the input of the PHY-side of interface wrapper of the PHY-side of PHY-MAC interface at least partially responsive to the detecting the asserting of indication of valid data and the de-asserting of indication of out-of-band data.

9. The method of claim 1, wherein filtering one or more symbols present at an input of a PHY-side of interface wrapper of the PHY-side of PHY-MAC interface comprises:
detecting a symbol corresponding to a predetermined symbol;
detecting at least one of: a de-asserting of an indication of valid data or an asserting of indication of out-of-band data;
starting suppressing signaling at the input of the PHY-side of interface wrapper of the PHY-side of PHY-MAC interface corresponding to the symbol at least partially responsive to the detecting at least one of: de-asserting of indication of valid data or the asserting of indication of out-of-band data;
detecting at least one of: an asserting of indication of valid data or a de-asserting of indication of out-of-band data; and
stopping suppressing signaling at the input of the PHY-side of interface wrapper of the PHY-side of PHY-MAC interface corresponding to the symbol at least partially responsive to at least one of: detecting the asserting of indication of valid data or the de-asserting of indication of out-of-band data.

10. An apparatus, comprising:
a PHY-side of PHY-MAC interface; and
a logic circuit provided at the PHY-side of PHY-MAC interface, the logic circuit including a filter to filter one or more symbols conveyed via the PHY-side of PHY-MAC interface.

11. The apparatus of claim 10, wherein the PHY-side of PHY-MAC interface comprises:
a PHY-side of interface; and
a PHY-side of interface wrapper,
wherein the filter is coupled to filter an input of the PHY-side of interface wrapper.

12. The apparatus of claim 11, wherein the filter to filter one or more symbols at least partially responsive to detection of out-of-band data.

13. The apparatus of claim 11, wherein the filter comprises:
a detection logic to detect one or both of: assertion of indication of out-of-band data or de-assertion of indication of valid data;
a match logic to detect a symbol corresponds to a predetermined symbol; and
a suppression logic to suppress signaling at the input of the PHY-side of interface wrapper of the PHY-side of PHY-MAC interface at least partially responsive to detection by the detection logic and detection by the match logic.

14. The apparatus of claim 13, wherein suppressed signaling is associated with a detected carrier state of a shared transmission medium.

15. The apparatus of claim 13, wherein the filter comprises:
a match logic to detect a symbol corresponds to a predetermined symbol; and
a suppression logic to suppress signaling at the input of the PHY-side of interface wrapper of the PHY-side of PHY-MAC interface at least partially responsive to detection by the match logic.

16. The apparatus of claim 11, wherein the filter comprises:
a detection logic to detect one or both of: assertion of indication of out-of-band data or assertion of indication of valid data; and
a suppression logic to suppress signaling at the input of the PHY-side of interface wrapper of the PHY-side of PHY-MAC interface at least partially responsive to detection by the detection logic.

17. The apparatus of claim 11, wherein the PHY-side of interface wrapper is a reduced media independent interface wrapper.

18. The apparatus of claim 10, wherein a filtered symbol is a physical layer collision avoidance symbol.
